(19) United States
(12) Patent Application Publication
(10) Pub. No.: US 2005/0144479 A1
(43) Pub. Date: Jun. 30, 2005

(54) Method, medium, and apparatus for processing cookies

(75) Inventor: Young-ran Son, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 10/986,155

(22) Filed: Nov. 12, 2004

(30) Foreign Application Priority Data
Nov. 14, 2003 (KR) 2003-80536

(51) Int. Cl. H04L 9/00

(52) U.S. Cl. 713/201

(57) ABSTRACT

A method, medium, and apparatus for processing large cookies, in an Internet communication, using a hyper text transfer protocol (HTTP), the method includes receiving a request from a client, creating a response containing a cookie in its body in response to the received request, and transmitting the created response to the client, and there is also provided an apparatus of processing a large cookie, in Internet communication, using a hyper text transfer protocol (HTTP), the apparatus including a request input unit to receive a request from a client, a response creating unit to create a response containing a cookie for the client in its body, and a response output unit to output the created response to the client.

### CROSS-REFERENCE TO RELATED APPLICATIONS

This application claims the priority benefit of Korean Patent Application No. 2003-80536, filed on Nov. 14, 2003, in the Korean Intellectual Property Office, the disclosure of which is incorporated herein in its entirety by reference.

### BACKGROUND OF THE INVENTION

1. Field of the Invention

The present invention relates to Internet communication, and more specifically, to communication using cookies between a web server and a client computer in a hyper text transfer protocol (hereinafter, referred to as HTTP) communication.

2. Description of the Related Art

While accessing web sites, there are some operations that developers cannot arbitrarily set or performs solely at a server, such as automatically logging into the web sites, displaying the number of visits to the web sites, etc. For security reasons, code existing within a web page is not allowed to record data in users' local disks. This is because such an operation would open up controllability of users' files, which can be recorded in the local disks.

However, a small data file(s), called cookies, can be recorded in the local disks, and the cookies may selectively not be stored, through options of a browser.

The cookies are data files which can be recorded onto users' computers, from web pages, in order to solve communication problems between conventional servers and clients not having had a session layer (or port layer) interaction, i.e., a series of interactions between communication end points that can occur during the span of a single connection. By using such data, it can be set that identifiers (IDs) and passwords to the web sites are stored, that the identifiers and passwords are automatically input, or that questionnaires are responded to only once.

The cookies were originally developed to help users' access home pages over Internet. When a user first visits a specific web site, a cookie, in which an identifier and a password are recorded, is prepared, and when the user visits the web site again, the user can rapidly gain access to the web site without additional procedures.

The cookies are typically stored in users' local computers as temporary files, and in an exemplary web browser, a maximum of 300 cookies can be stored, and a size of one cookie file is limited to 4 KB or less. A cookie indicates a place for continuously storing data in communication with a server, the place being a part of a memory area existing in a browser. The cookie can allow an inherent limit of the hyper text transfer protocol (HTTP), capable of not maintaining user data, to be overcome, so that each server can refer to data which browsers have, by using the cookies.

If a browser is stopped, contents of the cookies may be stored in files “Cookies.txt”, for example, and when the browser is next started, the contents of the files can be called up into memories. Servers can record some data in the cookies of the browser, and can refer to them any time. That is, a customized service can be provided.

However, since the browser allows only the corresponding server, having input values to the cookie, to see the values of the cookie, the server cannot refer to data of the cookie which the server has not input. Similarly, data of the cookie which a server has input cannot be referred to by different servers.

A web browser in use may automatically prepare a cookie, update the cookie, and may deliver the personal data to web sites. Therefore, privacy may be violated. This is because all the data of a user's traveling of the Internet can be recorded, or which products the user has bought, etc., may be available via cookies. Advertisement agents have usefully used the cookies to collect and analyze Internet users' tastes and prepare advertising strategies.

A cookie can be set to an attribute of “document.cookie”, and its format may be as follows:

Name=value; expire=expDate

Where, “name” corresponds to a name of a cookie which is stored in a virtual space of a browser and is used for identifying the cookies, “value” corresponds to a cookie value, “expire” corresponds to an ending time limit during which a cookie can exist as a keyword in a cookie file, and “expDate” corresponds to an ending time limit of a cookie constructed in a Greenwich mean time (GMT) format.

Communication using the cookie between a client and a web server is performed by way of headers of an HTTP response and request. When a cookie is transmitted to the client from the server, a field of “set-Cookie” is used, and when a cookie is transmitted to the server from the client, a header field of “Cookie” is used. The client generally limits the cookie to 4 KByte, as there occurs a problem that the total size of the header becomes increased when the cookie value has a large amount.

A client-side cookie method in which cookies are stored at the client side is mainly used, but a server-side cookie method in which cookies are stored at the server side may be used in order to solve the problem of permitting increased in the size of a cookie. In the server-side cookie method, the cookies are stored in a server side memory, and clients transmits session identifiers to use the cookies.

However, this method has problems that too much storage capacity is required at the server side, and when the server is caused to come down, the cookies stored at the server side may be lost.

### SUMMARY OF THE INVENTION

According to embodiments of the present invention, described below, it is possible to perform a HTTP communication, which does not require a high-capacity memory at a server side, can prevent cookies from being lost even when a server is caused to come down, and can process large cookies.

Additional aspects and/or advantages of the invention will be set forth in part in the description which follows and, in part, will be obvious from the description, or may be learned by practice of the invention.

To achieve the above and/or other aspects and advantages, embodiments of the present invention set forth a method of processing cookies in an Internet communication using a hyper text transfer protocol (HTTP), including receiving a request from a client, creating a response containing a cookie in its body in response to the received request, and transmitting the created response to the client.

“Content-type” in a header of the response may be set to “multipart”. Similarly, “Content-Disposition” in the body of the response may be set to a new identifier indicating the cookie. In addition to being in the body of the response, the cookie may be larger than 4 KB.

To achieve the above and/or other aspects and advantages, embodiments of the present invention set forth an apparatus of processing cookies in an Internet communication using a hyper text transfer protocol (HTTP), including a request input unit to receive a request from a client, a response creating unit to create a response containing a cookie for the client in its body in response to the received request, and a response output unit to output the created response to the client.

To achieve the above and/or other aspects and advantages, embodiments of the present invention set forth a method of processing cookies in an Internet communication using a hyper text transfer protocol (HTTP), including transmitting a communication containing a cookie in the communication's body, wherein the communication is created at a client and transmitted to a server.

Similar to above, “Content-type” in a header of the response may be set to “multipart”. Alternatively, “Content-type” in a header of the response may be set to “text/plain”. “Content-Disposition” in the body of the response may also be set to a new identifier indicating the cookie.

To achieve the above and/or other aspects and advantages, embodiments of the present invention set forth a client apparatus processing cookies in an Internet communication using a hyper text transfer protocol (HTTP), comprising transmitting a communication containing a cookie in the communication's body, wherein the communication is created at the client apparatus and transmitted to a server.

To achieve the above and/or other aspects and advantages, embodiments of the present invention set forth a medium including computer readable code controlling a computational device(s) to perform methods of the present invention, or including computer readable code representing a cookie included within a communication body according to embodiments of the present invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram schematically illustrating a client and a server between which hyper text transfer protocol (hereinafter, referred to as HTTP) communication is performed;

FIGS. 2 through 6 show contents of HTTP communications, using a cookie between a client 100 and a server 110, for processing cookies, according to embodiments of the present invention; and

FIG. 7 is a block diagram schematically illustrating an apparatus for processing cookies, according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

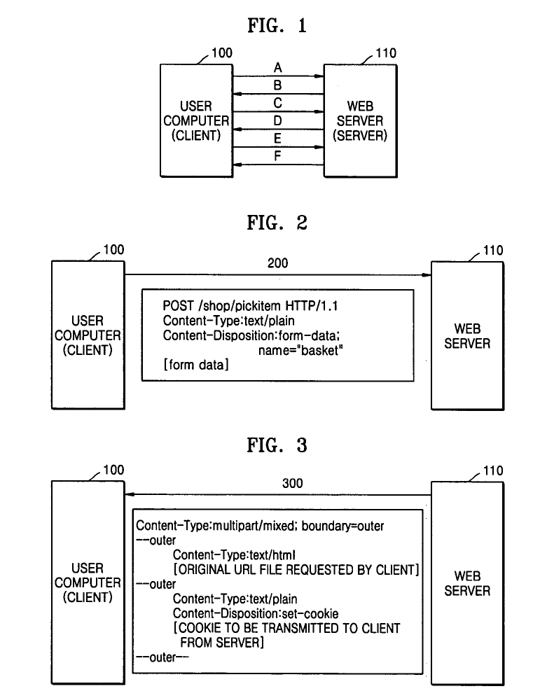

FIG. 1 is a block diagram schematically illustrating a client 100 (a user computer) and a server 110 (a web server) between which hyper text transfer protocol (hereinafter, referred to as HTTP) communication is performed. In FIG. 1, arrows A, B, C, D, E, and F between the client 100 and the server 110 indicate communication sequences, where the arrows A, C and E directed toward the server 110 from the client 100 indicate requests that the client 100 transmits to the server 110, and the arrows B, D and F directed toward the client 100 from the server 110 indicate responses that the server 110 transmits to the client 100. In FIG. 1, several requests and responses, from A through F, are exchanged, but the number of exchanges of the requests and the responses are not limited.

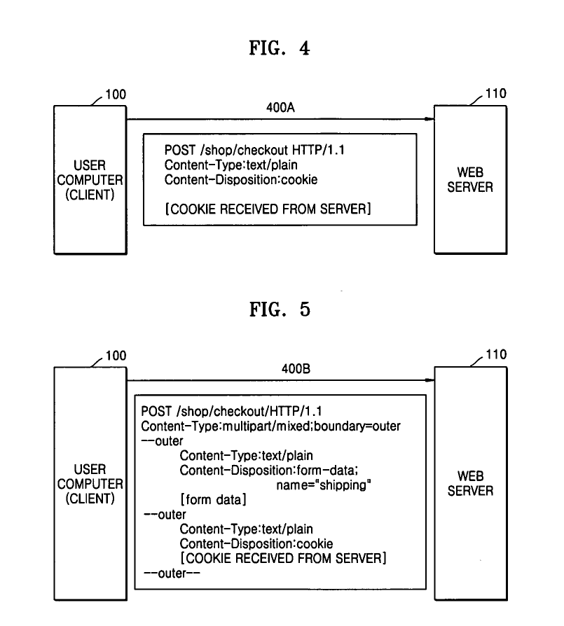

FIGS. 2 through 6 illustrate contents of the HTTP communication, using a cookie between the client 100 and the server 110, in embodiments for processing a large number of cookies, as well as large cookies, according to embodiments of the present invention. Detailed information on the requests and the responses in the HTTP communication can be obtained with reference to a web site, www.w3.org, for example.

First, in FIG. 2, the server 110 receives a request from the client 100 (operation 200). In the request of FIG. 2, a portion of “[form data]” is the body, and a portion above the body is the header. A size of the body is not limited. “POST,” at a first row of the header, indicates one of the primary request methods of the HTTP and corresponds to data being registered at a specified uniform resource locator (URL), and “HTTP/1.1” indicates the version of the same.

In FIG. 3, the server 110 creates a response containing a cookie, in its body, in response to the received request, and transmits the created response to the client 100 (operation 300). The server 110 processes the received request, and transmits a response containing the cookie in its body to the client 100 in order to maintain state data. At this time, it should be noted that the cookie is not contained in the response header like conventional cases, but in the response body.

“Content-type” in the response header is set to “multipart”. That is, since the original data requested by the client 100, and the cookie contents, are all contained in the response body and transmitted, a content type of “multipart/mixed” is used to represent that the body has two or more portions.

In FIG. 3, “[original URL file requested by client]” and “[cookie to be transmitted to client from server]” are contained in the body, and thus its sizes are not limited. “Outer” is a delimiter for discriminating a boundary between the file and the cookie.

“Content-Disposition,” in the response body, is set to a new identifier indicating the cookie. In this embodiment, in order to discriminate the cookie and the original response to be transmitted to the client 100, that is, the original uniform resource locator (URL) file requested by the client 100, “Content-Disposition” is set to “set-cookie”.

A next step will be described through example two embodiments. First, one embodiment represents a case where there is no data to be transmitted to the server 110 from the client 100, by using the “POST” method, except for the cookie. In conventional cases, only the header without the body can be transmitted to the server 110 by using a “GET” method, but in this embodiment, since the cookie should be contained in the body, and transmitted, the “POST” method should be used. However, since the body contains only the cookie, “Content-type” is not set to “multipart”, but is set to “text/plain” which a type corresponding to only the cookie content.

The client 100 transmits the request to the server 110, along with the cookie received from the server 110 in the previous operation 300 (operation 400A). In FIG. 4, “[cookie received from server]” is contained in the body, and thus the size thereof is not limited. In order to discriminate the data to be originally transmitted to the server 110, from the client 100, and the cookie, a field value of “Content-Disposition” is set to “cookie”.

Another embodiment represents a case where there is data to be transmitted to the server 110 by using the “POST” method, except for the cookie. In this case, the request contains the cookie in its body, and the client 100 transmits the request to the server 110 along with the cookie previously received from the server 110, in the previous operation 300 (operation 400B). Since the request is transmitted with the data and the cookie contained in its body, “Content-type” in the header is set to “multipart” in order to represent that two or more portions exist in the body.

Since “[form data]” and “[cookie received from server]” are contained in the body, the sizes thereof are not limited. “Content-Disposition” in the request body is set to a new identifier representing the cookie, where in this embodiment, the field value of “Content-Disposition” is set to “cookie,” in order to discriminate the data to be originally transmitted to the server 110 from the client 100 and the cookie.

In FIG. 6, the server 110 transmits the response to the client 100, and then finishes the transaction. In FIG. 6, “200” is an HTTP response message representing “OK”.

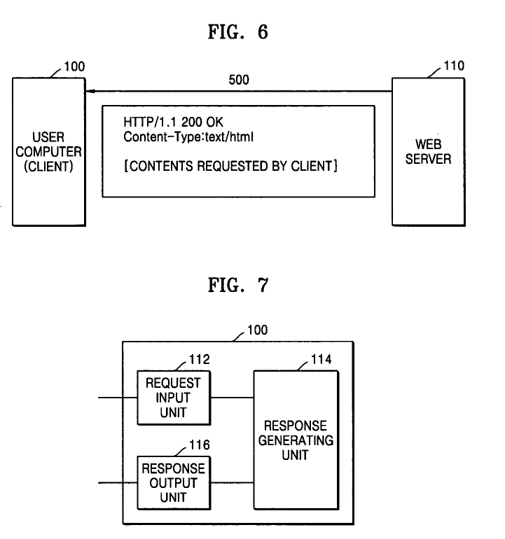

FIG. 7 is a block diagram schematically illustrating an apparatus for processing cookies, according to embodiments of the present invention.

The apparatus 110 processing a large cookie is a web server for performing Internet communication using the HTTP, and is denoted by the same reference numeral as in FIG. 1. The server 110 shown in FIG. 7 includes a request input unit 112, a response creating unit 114, and a response output unit 116 therein. In this embodiment, the request input unit 112 and the response output unit 116 are constructed separately, but may be constructed integrally in another embodiment.

The request input unit 112 receives a request from the client 100. As seen from FIG. 2, a portion of “[form data]” is a body of the request, and a portion above the body is a header. A size of the body is not limited. “POST,” at a first row of the header, indicates one of any primary request methods of the HTTP, and has a meaning that data is registered at a specified uniform resource locator (URL).

The response creating unit 114 creates a response containing a cookie for the client 100 in its body, and the response output unit 116 outputs the created response to the client 100. The server 110 processes the received request, and transmits the response containing the cookie to the client 100, in order to maintain state data. At this time, it should be noted that the cookie is not contained in the response header, like conventional cases, but in the response body.

The response creating unit 114 sets “Content-type” in the response header to “multipart”. That is, since the original data requested by the client 100 and the cookie contents are all contained in the response body and transmitted, a content type of “multipart/mixed” is used to represent that the body has two or more portions.

In FIG. 3, since “[original URL file requested by client]” and “[cookie to be transmitted to client from server]” are contained in the body, the sizes are not limited. The response creating unit 114 sets “Content-Disposition” in the response body to a new identifier indicating the cookie. In this embodiment, in order to discriminate the cookie and the original response to be transmitted to the client 100, that is, the original uniform resource locator (URL) file requested by the client 100, “Content-Disposition” is set to “set-cookie”.

FIGS. 4 and 5 illustrate embodiments where the client 100 can respond to the response transmitted from the server 110 in FIG. 3. First, the embodiment shown in FIG. 4 represents a case where there is no data to be transmitted to the server 110, from the client 100, by using the “POST” method except for the cookie. The client 100 transmited the request to the server 110, along with the cookie received from the server 110 in the previous operation 300 (operation 400A). In FIG. 4, since “[cookie received from server]” is contained in the body, the size of the cookie is not limited. In order to discriminate the data to be originally transmitted to the server 110 from the client 100 and the cookie, a field value of “Content-Disposition” is set to “cookie”.

Another embodiment shown in FIG. 5 represents a case where there is data to be transmitted to the server 110, by using the “POST” method, except for the cookie. In this case, the request contains the cookie in its body, and the client 100 transmits the request to the server 110 along with the cookie received from the server 110 in the previous opertion 300 (operation 400B). “Content-type” in the request header is set to “multipart”.

Since “[form data]” and “[cookie received from server]” are contained in the body, the sizes thereof are not limited. “Content-Disposition” in the request body is set to a new identifier representing the cookie, where in this embodiment, the field value of “Content-Disposition” is set to “cookie” in order to discriminate the data to be originally transmitted to the server 110 from the client 100 and the cookie.

In FIG. 6, the server 110 transmits the response to the client 100, and then finishes the transaction. In FIG. 6, “200” is an HTTP response message representing “OK”.

In addition to the above described embodiments, embodiments of the present invention can be implemented through computer readable code and implemented in general-use digital computers through use of a computer readable medium including the computer readable code. The computer readable medium can correspond to any medium/media permitting the storing or transmission of the computer readable code.

The structure of data used in the embodiments of the present invention described above can be recorded on a computer readable recording medium in a variety of ways. Examples of the computer readable medium may include magnetic storage media (e.g., ROM, floppy disks, hard disks, etc.), optical recording media (e.g., CD-ROMs, or DVDs), and storage media such as carrier waves (e.g., transmission through the Internet).

According to embodiments of the present invention described above, it is possible to perform an HTTP communication which does not require a high-capacity memory at a server side, can prevent cookies from being lost even when a server is caused to go down, and can process large cookies.

In other words, by using the fact that a length of a header is limited but a body is not limited, a problem of the browser not supporting a case where a cookie exceeds 4 Kbyte, in the conventional client-side cookie method, and the problem that too large of memory may be required at the server side in the conventional server-side cookie methods.

Although a few embodiments of the present invention have been shown and described, it would be appreciated by those skilled in the art that changes may be made in these embodiments without departing from the principles and spirit of the invention, the scope of which is defined in the claims and their equivalents.

1. A method of processing cookies in an Internet communication using a hyper text transfer protocol (HTTP), comprising:
receiving a request from a client;
creating a response containing a cookie in its body in response to the received request; and
transmitting the created response to the client.

2. The method of claim 1, wherein “Content-type” in a header of the response is set to “multipart”.

3. The method of claim 1, wherein “Content-Disposition” in the body of the response is set to a new identifier indicating the cookie.

4. The method of claim 1, wherein the request contains the cookie in its body.

5. The method of claim 4, wherein “Content-type” in a header of the request is set to “multipart”.

6. The method of claim 4, wherein “Content-Disposition” in the body of the request is set to a new identifier indicating the cookie.

7. The method of claim 1, wherein the cookie is larger than 4 KB.

8. An apparatus for processing cookies in an Internet communication using a hyper text transfer protocol (HTTP), the apparatus comprising:
a request input unit to receive a request from a client;
a response creating unit to create a response containing a cookie for the client in its body in response to the received request; and
a response output unit to output the created response to the client.

9. The apparatus of claim 8, wherein the response creating unit sets “Content-type” in a response header to “multipart”.

10. The apparatus of claim 8, wherein the response creating unit sets “Content-Disposition” in the response body to a new identifier indicating the cookie.

11. The apparatus of claim 8, wherein the request contains the cookie in its body.

12. The apparatus of claim 11, wherein “Content-type” in a header of the request is set to “multipart”.

13. The apparatus of claim 11, wherein “Content-Disposition” in the request body is set to a new identifier indicating the cookie.

14. The apparatus of claim 8, wherein the cookie is larger than 4 KB.

15. A method of processing cookies in an Internet communication using a hyper text transfer protocol (HTTP), comprising:
transmitting a communication containing a cookie in the communication's body,
wherein the communication is created at a client and transmitted to a server.

16. The method of claim 15, wherein “Content-type” in a header of the response is set to “multipart”.

17. The method of claim 15, wherein “Content-type” in a header of the response is set to “text/plain”.

18. The method of claim 15, wherein “Content-Disposition” in the body of the response is set to a new identifier indicating the cookie.

19. The method of claim 15, wherein the cookie is larger than 4 KB.

20. A client apparatus processing cookies in an Internet communication using a hyper text transfer protocol (HTTP), comprising transmitting a communication containing a cookie in the communication's body, wherein the communication is created at the client apparatus and transmitted to a server.

21. A medium comprising computer readable code controlling a computational device(s) to perform the method of claim 1.

22. A medium comprising computer readable code controlling a computational device(s) to perform the method of claim 15.

23. A medium comprising computer readable code representing a cookie included in a communication body according to the method of claim 1.

24. A medium comprising computer readable code representing a cookie included in a communication body according to the method of claim 15.
